(19) United States
(12) Patent Application Publication
(10) Pub. No.: US 2025/0315641 A1
(43) Pub. Date: Oct. 9, 2025

(54) SYSTEMS AND METHODS FOR AUTOMATICALLY CREATING AND TRAINING VIRTUAL ASSISTANTS

(71) Applicant: KORE.AI, INC., Orlando, FL (US)

(72) Inventors: Rajkumar KONERU, Windermere, FL (US); Prasanna Kumar ARIKALA GUNALAN, Hyderabad (IN); Sri Vishnu SANKAR SRINIVASAN, Chennai (IN); Jayesh ARUNKUMAR JAIN, Bhusawal (IN)

(21) Appl. No.: 18/969,068

(22) Filed: Dec. 4, 2024

Related U.S. Application Data
(60) Provisional application No. 63/574,704, filed on Apr. 4, 2024.

(51) Int. Cl. G06N 3/006; G06F 40/40; G06N 3/08

(52) U.S. Cl. CPC G06N 3/006; G06F 40/40; G06N 3/08

(57) ABSTRACT

A method comprises creating each of the conversation experiments upon generating a first user utterance of each of the conversation experiments based on received data inputs. For each of the conversation experiments the creating further comprises: generating one or more virtual assistant responses/actions or subsequent user utterances based on at least one of the data inputs or a prior version of a current one of the conversation experiments; validating each of the one or more virtual assistant responses/actions or the subsequent user utterances against validation data. Additionally, the current conversation experiment is updated only upon the successful validation of the corresponding one of the one or more virtual assistant responses/actions or the subsequent user utterances. Further, the generating and the validating are repeated until exit condition(s) are satisfied for the current conversation experiment. Subsequently, a virtual assistant model is trained with the created conversation experiments.

This application claims priority of U.S. Provisional Patent Application Ser. No. 63/574,704, filed Apr. 4, 2024.

### FIELD

This technology generally relates to virtual assistants, and more particularly to methods, systems, and computer-readable media for automatically creating conversation experiments and training virtual assistants with the created conversation experiments.

### BACKGROUND

In today's data-driven world, artificial intelligence (AI) and/or machine learning (ML) based virtual assistants are deployed for various use cases in different domains including banking (e.g., balance enquiry, transfer funds, open account), travel (e.g., book ticket, cancel ticket, book hotel), food (e.g., order food, check order status), healthcare (e.g., schedule appointment, change appointment, book lab tests), retail (e.g., place order, cancel order, request exchange), or the like. However, one of the biggest challenges for developers or data scientists in developing AI/ML based virtual assistants is to manually source or create quality and robust training datasets that cover different use cases and scenarios. Additionally, manually creating quality and robust training datasets is an expensive and time-consuming activity, which can impact development, testing and deployment of virtual assistants.

Additionally, there are various reasons for the scarcity of publicly available datasets for certain use cases for training the virtual assistants. For example, some datasets may contain information about an organization's day to day internal operations, financial data, and/or personally identifiable information (PII) of customers (hereinafter referred to as “users”) of the organization which are confidential and thus, the organizations can be reluctant to share these datasets with other organizations such that robust training datasets can be generated. Additionally, there are often legal issues and privacy concerns with sharing collected user data especially in certain fields like financial services and health care. Further, removing PII data or confidential data from datasets before training the virtual assistants is an expensive and time-consuming task.

To overcome the above-mentioned drawbacks of manually creating training datasets for AI/ML based virtual assistants, developers and/or data scientists are making use of generative AI capabilities of large language models (LLMs) to generate synthetic data that may be used as training datasets for virtual assistants. Synthetic data may be referred to as the data that is not collected from users but is artificially generated by an LLM that mimics data patterns, characteristics, and relationships found in real-world data. Synthetic data is generated to mimic real-world data, making it a valuable resource to train, test, and refine AI/ML based virtual assistants. Further, when compared to real-world data, synthetic data can be customizable to meet specific training needs, cost effective and generated quickly.

Despite offering numerous advantages, synthetic data does have limitations. For example, previously, to generate accurate and quality synthetic data, required an understanding of data modeling, characteristics of the LLM used for generating synthetic data, and a clear knowledge of real-world data which is not a skill set that is readily available. As another example, LLMs are prone to hallucinations and may generate false information, so previously generated synthetic data need manual validation for accuracy, quality and reliability which can be time consuming and expensive. As a further example, for complex use cases, the generation of synthetic data covering all possible scenarios has historically been a very challenging, expensive and time consuming process.

To address the above-mentioned limitations, there is a need for systems and methods to leverage LLMs to generate quality and robust synthetic data that may be used for training AL/ML based virtual assistants.

### SUMMARY

In an example, the present disclosure relates to a method for automatically creating conversation experiments and training virtual assistants with the created conversation experiments. The method comprises receiving a plurality of data inputs from a developer device to generate conversation experiments for a use case. The method further comprises creating each of the conversation experiments upon generating a first user utterance of each of the conversation experiments corresponding to the use case based on the plurality of data inputs. The creating of each of the conversation experiments further comprises: generating one or more virtual assistant responses, virtual assistant actions, or subsequent user utterances, based on at least one of the plurality of data inputs or a prior version of a current one of the conversation experiments; validating each of the one or more generated virtual assistant responses, the virtual assistant actions, or the subsequent user utterances against validation data, wherein the current one of the conversation experiments is updated only upon the successful validation of the corresponding one of the one or more virtual assistant responses, the virtual assistant actions, or the subsequent user utterances; and repeating the generating and the validating until one or more exit conditions are satisfied for the current one of the conversation experiments. Subsequently, training a virtual assistant model with at least one of the created conversation experiments when the one or more exit conditions are satisfied for the at least one of the conversation experiments.

In another example, the present disclosure relates to a virtual assistant server comprising one or more processors and a memory. The memory coupled to the one or more processors which are configured to execute programmed instructions stored in the memory to receive a plurality of data inputs from a developer device to generate conversation experiments for a use case. The one or more processors are further configured to create each of the conversation experiments upon generating a first user utterance of each of the conversation experiments corresponding to the use case based on the plurality of data inputs. To create each of the conversation experiments, the one or more processors are further configured to: generate one or more virtual assistant responses, virtual assistant actions, or subsequent user utterances, based on at least one of the plurality of data inputs or a prior version of a current one of the conversation experiments; validate each of the one or more generated virtual assistant responses, the virtual assistant actions, or the subsequent user utterances against validation data, wherein the current one of the conversation experiments is updated only upon the successful validation of the corresponding one of the one or more virtual assistant responses, the virtual assistant actions, or the subsequent user utterances; and repeat the generate and the validate until one or more exit conditions are satisfied for the current one of the conversation experiments. Subsequently, train a virtual assistant model with at least one of the created conversation experiments when the one or more exit conditions are satisfied for the at least one of the conversation experiments.

In another example, the present disclosure relates to a non-transitory computer readable storage medium storing thereon instructions which when executed by one or more processors, causes the one or more processors to receive a plurality of data inputs from a developer device to generate conversation experiments for a use case. The one or more processors are further configured to create each of the conversation experiments upon generating a first user utterance of each of the conversation experiments corresponding to the use case based on the plurality of data inputs. To create each of the conversation experiments, the one or more processors are further configured to: generate one or more virtual assistant responses, virtual assistant actions, or subsequent user utterances, based on at least one of the plurality of data inputs or a prior version of a current one of the conversation experiments; validate each of the one or more generated virtual assistant responses, the virtual assistant actions, or the subsequent user utterances against validation data, wherein the current one of the conversation experiments is updated only upon the successful validation of the corresponding one of the one or more virtual assistant responses, the virtual assistant actions, or the subsequent user utterances; and repeat the generate and the validate until one or more exit conditions are satisfied for the current one of the conversation experiments. Subsequently, train a virtual assistant model with at least one of the created conversation experiments when the one or more exit conditions are satisfied for the at least one of the conversation experiments.

### BRIEF DESCRIPTION OF THE DRAWINGS

FIG. 1A is a block diagram of an exemplary environment with a virtual assistant server configured to automatically create conversation experiments and train virtual assistants with the created conversation experiments.

FIG. 1B is a block diagram of the virtual assistant platform of the virtual assistant server illustrated in FIG. 1A.

FIG. 2 is an example wireframe of a graphical user interface of an experiment generator that is displayed to a developer at a developer device.

FIG. 3 is a flowchart of an exemplary method for automatically creating conversation experiments and training virtual assistants with the created conversation experiments.

FIG. 4A is an exemplary functional block diagram illustrating components of the environment 100 of FIG. 1A that interact with one another to implement the exemplary method of FIG. 3 to create conversation experiments.

FIG. 4B is an exemplary functional block diagram illustrating components of the virtual assistant server environment 100 of FIG. 1A that interact with one another to generate possible conversation paths from the data inputs received from a developer device.

FIG. 4C is an exemplary functional block diagram illustrating components of the environment 100 of FIG. 1A that interact with one another to implement the exemplary method of FIG. 3 to train a virtual assistant model with the created conversation experiments.

FIG. 5 is a sequence diagram illustrating an exemplary method for generating conversation experiments by the experiment generator.

FIG. 6 is an example conversation tree that illustrates the way the conversation experiments are generated for a given use case.

### DESCRIPTION

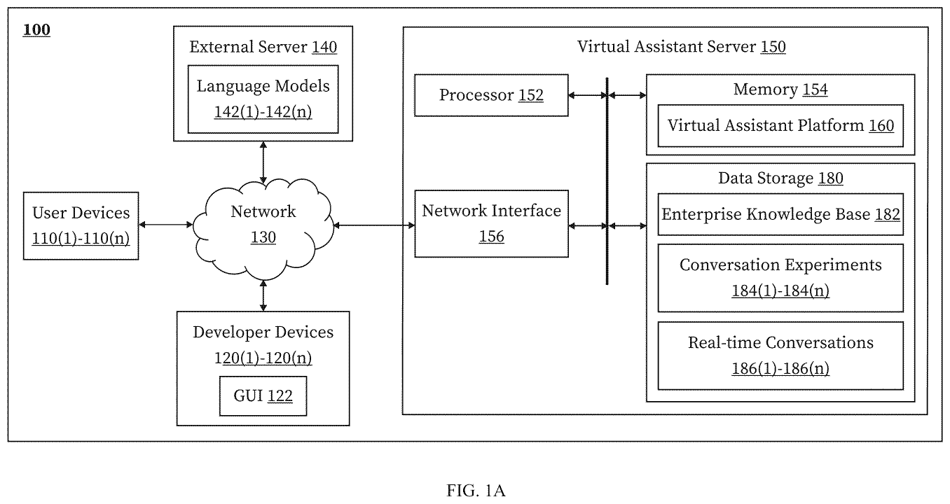

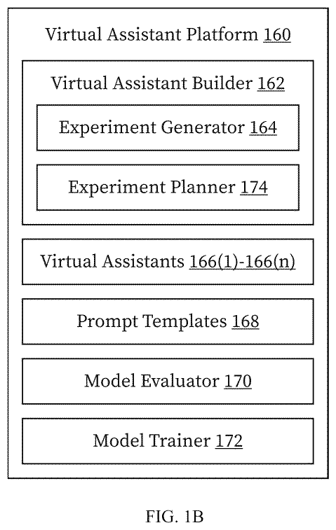

Examples of the present disclosure relate to a virtual assistant server environment 100 (illustrated in FIG. 1A) and, more particularly, to one or more components, systems, computer-readable media and methods for leveraging LLMs to generate quality and robust synthetic training data for AI/ML based virtual assistants. The virtual assistant server environment 100 enables developers or administrators of enterprises operating enterprise devices to, by way of example, design, develop, deploy, manage, host, and analyze virtual assistants. Further, the virtual assistant server environment 100 enables developers or administrators of the enterprises operating the enterprise devices to, by way of example, train, optimize and use LLMs. A virtual assistant server 150 of the virtual assistant server environment 100 is configured to orchestrate natural language conversations between users and the virtual assistants.

FIG. 1A is a block diagram of an exemplary virtual assistant server environment 100 for implementing the concepts and technologies disclosed herein. The virtual assistant server environment 100 includes: one or more user devices 110(1)-110(n), one or more developer devices 120(1)-120(n), an external server 140, and a virtual assistant server 150 all coupled together via a network 130, although the virtual assistant server environment 100 can include other types and numbers of systems, devices, components, and/or elements and in other topologies and deployments. Although not illustrated, the virtual assistant server environment 100 may include additional network components, such as routers, switches, and other devices, which are well known to those of ordinary skill in the art and thus will not be described here.

The one or more user devices 110(1)-110(n) may comprise one or more processors, one or more memories, one or more input devices such as a keyboard, a mouse, a display device, a touch interface, and/or one or more communication interfaces, which may be coupled together by a bus or other link, although the one or more user devices 110(1)-110(n) may have other types and/or numbers of other systems, devices, components, and/or other elements. The users accessing the one or more user devices 110(1)-110(n) provide inputs/utterances (e.g., in text or voice) to the virtual assistant server 150. The virtual assistant server 150 provides responses to the utterances using the virtual assistants. In one example, the virtual assistant server 150 may also communicate with the external server 140 to provide responses to the utterances.

The one or more developer devices 120(1)-120(n) may communicate with the virtual assistant server 150 and/or the external server 140 via the network 130. The one or more developers at the one or more developer devices 120(1)-120(n) may access and interact with the functionalities exposed by the virtual assistant server 150 and/or the external server 140 via the one or more developer devices 120(1)-120(n). The one or more developer devices 120(1)-120(n) may include any type of computing device that can facilitate user interaction, for example, a desktop computer, a laptop computer, a tablet computer, a smartphone, a mobile phone, a wearable computing device, or any other type of device with communication and data exchange capabilities. The one or more developer devices 120(1)-120(n) may include software and hardware capable of communicating with the virtual assistant server 150 and/or the external server 140 via the network 130. Also, the one or more developer devices 120(1)-120(n) may comprise a graphical user interface (GUI) 122 to render and display the information received from the virtual assistant server 150 and/or the external server 140. The one or more developer devices 120(1)-120(n) may communicate with the virtual assistant server 150 and/or the external server 140 via one or more application programming interfaces (APIs) or one or more hyperlinks exposed by the virtual assistant server 150 and/or the external server 140 respectively, although other types and/or numbers of communication methods may be used in other configurations.

The one or more developer devices 120(1)-120(n) may run applications, such as web browsers or virtual assistant software, which may render the GUI 122, although other types and/or numbers of applications may render the GUI 122 in other configurations. In one example, the one or more developers at the one or more developer devices 120(1)-120(n) may, by way of example, make selections, provide inputs using the GUI 122 or interact, by way of example, with data, icons, widgets, or other components displayed in the GUI 122.

The network 130 enables the one or more user devices 110(1)-110(n), the one or more developer devices 120(1)-120(n), the external server 140, or other such devices to communicate with the virtual assistant server 150. The network 130 may be, for example, an ad hoc network, an extranet, an intranet, a wide area network (WAN), a virtual private network (VPN), a local area network (LAN), a wireless LAN (WLAN), a wireless WAN (WWAN), a metropolitan area network (MAN), internet, a portion of the internet, a portion of the public switched telephone network (PSTN), a cellular telephone network, a wireless network, a Wi-Fi network, a worldwide interoperability for microwave access (WiMAX) network, or a combination of two or more such networks, although the network 130 may include other types and/or numbers of networks in other topologies or configurations.

The network 130 may support protocols such as, Session Initiation Protocol (SIP), Hypertext Transfer Protocol (HTTP), Hypertext Transfer Protocol Secure (HTTPS), Media Resource Control Protocol (MRCP), Real Time Transport Protocol (RTP), Real-Time Streaming Protocol (RTSP), Real-Time Transport Control Protocol (RTCP), Session Description Protocol (SDP), Web Real-Time Communication (WebRTC), Transmission Control Protocol/Internet Protocol (TCP/IP), User Datagram Protocol (UDP), or Voice over Internet Protocol (VOIP), although other types and/or numbers of protocols may be supported in other topologies or configurations. The network 130 may also support standards or formats such as, for example, hypertext markup language (HTML), extensible markup language (XML), voiceXML, call control extensible markup language (CCXML), JavaScript object notation (JSON), although other types and/or numbers of data, media, and document standards and formats may be supported in other topologies or configurations. A network interface 156 of the virtual assistant server 150 may include any interface that is suitable to connect with any of the above-mentioned network types and communicate using any of the above-mentioned network protocols, standards, or formats.

The external server 140 may host and/or manage a plurality of language models 142(1)-142(n). In one example, the plurality of language models 142(1)-142(n) may comprise: one or more large language models (LLMs), one or more small language models, one or more neural network models, or one or more hybrid models, although the plurality of language models 142(1)-142(n) may comprise any other types or numbers of language models. Further, in another example, the one or more LLMs that are used as the plurality of language models 142(1)-142(n) may be pre-trained general purpose LLMs (e.g., LLAMA 2, Claude, Cohere, Mistral 7B, Flan T5, BERT, GPT 3.5, GPT 4, . . . ) or fine-tuned LLMs for an enterprise or one or more domains. The external server 140 may create, host, and/or manage the plurality of language models 142(1)-142(n) based on training provided by the one or more developers using the one or more developer devices 120(1)-120(n). The external server 140 may be a cloud-based server or an on-premises server. The plurality of language models 142(1)-142(n) may be accessed using application programming interfaces (APIs). In another example, the plurality of language models 142(1)-142(n) may be hosted by the external server 140 and managed remotely by the virtual assistant server 150. In another example, the plurality of language models 142(1)-142(n) may be hosted and/or managed by the virtual assistant server 150.

An LLM is a type of AI-ML model that is used to process natural language data for tasks such as natural language processing, natural language understanding, text mining, text classification, machine translation, question-answering, text generation, or the like. The LLM uses deep learning or neural networks to learn language features or data patterns from large amounts of training data, which is then used to generate predictions or features or patterns from unseen data. The LLM can be used to generate language features such as word embeddings, part-of-speech tags, named entity recognition, sentiment analysis, or the like. Unlike traditional rule-based NLP systems, the LLM does not rely on pre-defined rules or templates to generate text or responses. Instead, the LLM uses a probabilistic approach to generate text, where the LLM calculates the probability of each word in the text based on the patterns the LLM learned from the training data.

The virtual assistant server 150 includes a processor 152, a memory 154, a network interface 156, and a data storage 180, although the virtual assistant server 150 may include other types and/or numbers of components in other configurations in other examples. In addition, the virtual assistant server 150 may include an operating system (not shown). In one example, the virtual assistant server 150, one or more components of the virtual assistant server 150, and/or one or more processes performed by the virtual assistant server 150 may be implemented using a networking environment (e.g., cloud computing environment). In one example, the capabilities of the virtual assistant server 150 may be offered as a service using the cloud computing environment.

The components of the virtual assistant server 150 may be coupled by a graphics bus, a memory bus, an Industry Standard Architecture (ISA) bus, an Extended Industry Standard Architecture (EISA) bus, a Micro Channel Architecture (MCA) bus, a Video Electronics Standards Association (VESA) Local bus, a Peripheral Component Interconnect (PCI) bus, a PCI-Express (PCIe) bus, a serial advanced technology attachment (SATA) bus, a Personal Computer Memory Card Industry Association (PCMCIA) bus, an Small Computer Systems Interface (SCSI) bus, or a combination of two or more of these, although other types and/or numbers of buses may be used in other configurations.

The processor 152 of the virtual assistant server 150 may execute one or more computer-executable instructions stored in the memory 154 for the methods illustrated and described with reference to the examples herein, although the processor 152 may execute other types and numbers of instructions and perform other types and numbers of operations. The processor 152 may comprise one or more central processing units (CPUs), or general-purpose processors with a plurality of processing cores, such as Intel® processor(s), AMD® processor(s), although other types of processor(s) could be used in other configurations. Although the virtual assistant server 150 may comprise multiple processors, only a single processor (i.e., the processor 152) is illustrated in FIG. 1A for simplicity.

The memory 154 of the virtual assistant server 150 is an example of a non-transitory computer readable storage medium capable of storing information or instructions for the processor 152 to operate on. The instructions, which when executed by the processor 152, perform one or more of the disclosed examples. In one example, the memory 154 may be a random access memory (RAM), a dynamic random access memory (DRAM), a static random access memory (SRAM), a persistent memory (PMEM), a non-volatile dual in-line memory module (NVDIMM), a hard disk drive (HDD), a read only memory (ROM), an crasable programmable read-only memory (EPROM), an electrically erasable programmable read-only memory (EEPROM), a programmable ROM (PROM), a flash memory, a compact disc (CD), a digital video disc (DVD), a magnetic disk, a universal serial bus (USB) memory card, a memory stick, or a combination of two or more of these. It may be understood that the memory 154 may include other electronic, magnetic, optical, electromagnetic, infrared or semiconductor based non-transitory computer readable storage medium which may be used to tangibly store instructions, which when executed by the processor 152, perform the disclosed examples. The non-transitory computer readable medium is not a transitory signal per se and is any tangible medium that contains and stores the instructions for use by or in connection with an instruction execution system, apparatus, or device. Examples of the programmed instructions and steps stored in the memory 154 are illustrated and described by way of the description and examples herein.

As illustrated in FIG. 1A, the memory 154 may include instructions corresponding to a virtual assistant platform 160 of the virtual assistant server 150, although other types and/or numbers of instructions in the form of programs, functions, methods, procedures, definitions, subroutines, or modules may be stored. The memory 154 may also include data structures storing information corresponding to the virtual assistant platform 160. The virtual assistant server 150 receives communications/instructions from one or more users at the one or more user devices 110(1)-110(n) and/or one or more developers at the one or more developer devices 120(1)-120(n) and uses the virtual assistant platform 160 to provide responses to the received communications and/or perform necessary actions based on the received instructions.

The network interface 156 may include hardware, software, or a combination of hardware and software, enabling the virtual assistant server 150 to communicate with the components illustrated in the virtual assistant server environment 100, although the network interface 156 may enable communication with other types and/or number of components in other configurations. In one example, the network interface 156 provides interfaces between the virtual assistant server 150 and the network 130. The network interface 156 may support wired or wireless communications. In one example, the network interface 156 may include an Ethernet adapter or a wireless network adapter to communicate with the network 130.

The users at the one or more user devices 110(1)-110(n) may access and interact with the functionalities exposed by the virtual assistant server 150 via the network 130. The one or more user devices 110(1)-110(n) may include any type of computing device that can facilitate user interaction, for example, a desktop computer, a laptop computer, a tablet computer, a smartphone, a mobile phone, a wearable computing device, or any other type of device with communication and data exchange capabilities. The one or more user devices 110(1)-110(n) may include software and hardware capable of communicating with the virtual assistant server 150 via the network 130. Also, the one or more user devices 110(1)-110(n) may render and display the information received from the virtual assistant server 150.

The users at the one or more user devices 110(1)-110(n) may interact with the virtual assistant server 150 via the network 130 by providing text utterances, voice utterances, or a combination of text and voice utterances via one or more communication channels. The one or more communication channels may include channels such as, enterprise messengers (e.g., Skype for Business, Microsoft Teams, Kore.ai Messenger, Slack, Google Hangouts, or the like), social messengers (e.g., Facebook Messenger, WhatsApp Business Messaging, Twitter, Lines, Telegram, or the like), web & mobile channels (e.g., a web application, a mobile application), interactive voice response (IVR) channels, voice channels (e.g., Google Assistant, Amazon Alexa, or the like), live chat channels (e.g., LivePerson, LiveChat, Zendesk Chat, Zoho Desk, or the like), a webhook channel, a short messaging service (SMS), email, a software-as-a-service (SaaS) application, voice over internet protocol (VOIP) calls, computer telephony calls, or the like. It may be understood that to support voice-based communication channels, the virtual assistant server environment 100 may include, for example, a public switched telephone network (PSTN), a voice server, a text-to-speech (TTS) engine, and/or an automatic speech recognition (ASR) engine.

Further, as illustrated in FIG. 1A, the data storage 180 may comprise an enterprise knowledge base 182, a plurality of conversation experiments 184(1)-184(n), and a plurality of real-time conversations 186(1)-186(n), although not illustrated, the data storage 180 may store other types of information in other examples. The enterprise knowledge base 182 may comprise enterprise specific information such as, for example, products and services information, business rules, product and service documents, privacy documents, policy documents, or the like, in the form of, for example, frequently asked questions (FAQs), online content (e.g., articles, books, magazines, PDFs, web pages, product menu, services menu), audio-video data, or graphical data that may be organized as relational data, tabular data, knowledge graph, or the like. Although, the enterprise knowledge base 182 may comprise any other types and/or numbers of enterprise specific information in any other types and/or numbers of formats in other examples. The enterprise knowledge base 182 may be accessed by the virtual assistant platform 160 while handling user conversations to respond to user queries/requests. Also, while developing and/or training the virtual assistants, the developers at the one or more developer devices 120(1)-120(n) may interact with the enterprise knowledge base 182, for example, using the GUI 122, although other manners for interacting with the enterprise knowledge base 182 may be used in other examples. The enterprise knowledge base 182 may be dynamically or periodically updated. The enterprise knowledge base 182 may comprise a number of different databases, some of which may be internal or external to the virtual assistant server 150. Although there may be multiple databases, a single enterprise knowledge base 182 is illustrated in FIG. 1A for simplicity.

The conversation experiments 184(1)-184(n) may refer to synthetic conversations that are generated using the plurality of language models 142(1)-142(n) to evaluate and train the virtual assistants of an enterprise. The real-time conversations 186(1)-186(n) may refer to, in one example, recordings and/or transcripts of actual conversations between one or more users at one or more of the plurality of user devices 110(1)-110(n) and one or more virtual assistants of the enterprise. In another example, the real-time conversations 186(1)-186(n) may comprise recordings and/or transcripts of actual conversations between one or more users the one or more of the plurality of user devices 110(1)-110(n) and one or more human agents of the enterprise.

FIG. 1B is a block diagram of the virtual assistant platform 160 of the virtual assistant server 150 illustrated in FIG. 1A. As illustrated in FIG. 1B, the virtual assistant platform 160 comprises instructions or data corresponding to a virtual assistant builder 162, one or more virtual assistants 166(1)-166(n), prompt templates 168, a model evaluator 170, and a model trainer 172, although other types and/or numbers of instructions or data in the form of programs, functions, methods, procedures, definitions, subroutines, modules, or structured or unstructured text, may be stored on the virtual assistant platform 160 in other examples. Examples of the steps or functions performed when the programmed instructions stored in the memory 154 are executed are illustrated and described by way of the figures and description associated with the examples herein.

The virtual assistant builder 162 of the virtual assistant platform 160 may be served from and/or hosted on the virtual assistant server 150 and may be accessible as a website, a web application, or a software-as-a-service (SaaS) application. Enterprise users, such as developers or business analysts, by way of example, may access the functionalities of the virtual assistant builder 162, for example, using web requests, API requests, although the functionalities of the virtual assistant builder 162 may be accessed using other types and/or numbers of methods in other examples. One or more developers at the one or more developer devices 120(1)-120(n) may design, create, configure, and/or train one or more virtual assistants 166(1)-166(n) using the GUI 122 provided by the virtual assistant builder 162. In one example, the functionalities of the virtual assistant builder 162 may be exposed as the GUI 122 rendered in a web page in the web browser accessible using the one or more developer devices 120(1)-120(n), such as a desktop or a laptop by way of example. The one or more developers at the one or more developer devices 120(1)-120(n) may interact with user interface (UI) components, such as windows, tabs, widgets, or icons in the GUI 122 rendered in the one or more developer devices 120(1)-120(n) to create, train, deploy, manage and/or optimize the one or more virtual assistants 166(1)-166(n). The virtual assistant builder 162 described herein can be integrated with different application platforms, such as development platforms or development tools or components thereof already existing in the marketplace, e.g., Facebook® Messenger, Microsoft® Bot Framework, third-party LLM platforms such as Open AI through APIs by way of example.

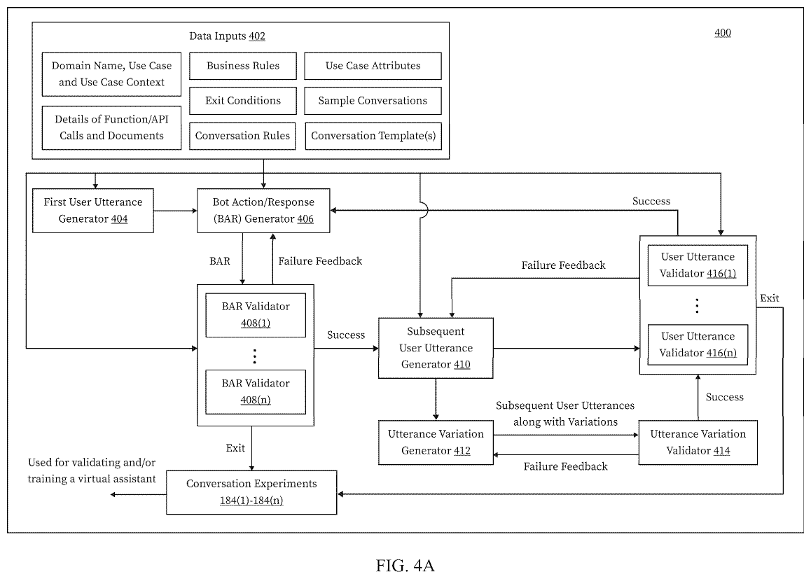

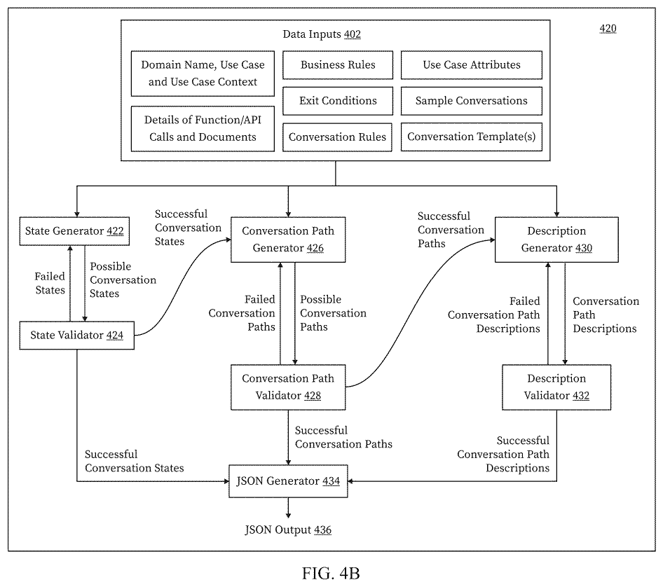

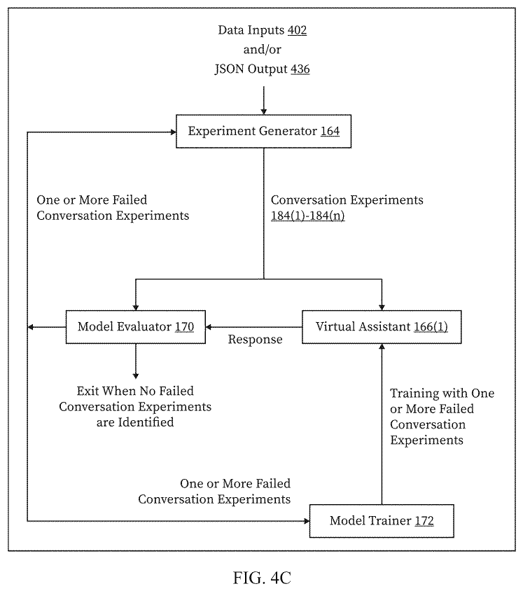

As illustrated in FIG. 1B, the virtual assistant builder 162 comprises an experiment planner 174 and an experiment generator 164. The experiment planner 174 is used to generate: conversation states, conversation paths/scenarios, and descriptions of conversation states and transition conditions, in unstructured text format, based on the data inputs provided by the one or more developers at the one or more developer devices 120(1)-120(n), which may be provided to the experiment generator 164 along with other data inputs to generate the conversation experiments 184(1)-184(n). The experiment planner 174 may be accessed by the enterprise users via the GUI 122 of the virtual assistant builder 162. For example, the settings/configuration/functionalities of the experiment planner 174 may be accessed by the enterprise users by clicking on a corresponding tab or icon or widget in the GUI 122 of the virtual assistant builder 162. In one example, instead of implementing the experiment planner 174 as part of the virtual assistant builder 162, the experiment planner 174 may be implemented as a separate component on the virtual assistant platform 160 or the virtual assistant server 150. In another example, instead of implementing the experiment planner 174 as a separate component on the virtual assistant builder 162, the experiment planner 174 may be implemented as part of the experiment generator 164. Further, in one example, the output of the experiment planner 174 may be converted into a structured format, such as, for example, a JavaScript Object Notation (JSON) format, or any other structured format. The details about the functionalities of the experiment planner 174 are described below in detail with reference to FIG. 4B.

The experiment generator 164 is used to generate synthetic conversations, hereinafter known as “conversation experiments 184(1)-184(n)” in the examples herein, for evaluating and training the one or more virtual assistants 166(1)-166(n). The experiment generator 164 may be accessed by the enterprise users via the GUI 122 of the virtual assistant builder 162. For example, the settings/configuration/functionalities of the experiment generator 164 may be accessed by the enterprise users by clicking on a corresponding tab or icon or widget in the GUI 122 of the virtual assistant builder 162. In one example, instead of implementing the experiment generator 164 as part of the virtual assistant builder 162, the experiment generator 164 may be implemented as a separate component on the virtual assistant platform 160 or the virtual assistant server 150. The enterprise users via the experiment generator 164 may provide data inputs for generating the conversation experiments 184(1)-184(n) that may be used for evaluating and training the one or more virtual assistants 166(1)-166(n). The data inputs may comprise at least one or more of, for example, domain name, one or more use cases, description of the one or more use cases, one or more business rules, one or more exit conditions, one or more conversation rules, one or more attributes to collect from users (i.e., use case attributes), a predefined set of conversation templates, one or more sample conversations for each of the one or more use cases, summary of each of the one or more sample conversations, details about function/API calls (e.g., name of the call, description of the call, URL, attributes/parameters of the call, etc.), details about internal or external databases, or details about internal or external documents/files (e.g., locations/URLs of the documents/files, type of the documents/files, description of the documents/files, etc.), although the enterprise users may provide any other types of data inputs in other examples.

### Definitions

The use case may be defined as a purpose of the user that the virtual assistant needs to fulfill.

The one or more business rules of an enterprise are predefined guidelines that dictate how the virtual assistant should behave or respond while fulfilling the use case.

The one or more conversation rules are predefined guidelines defined by the enterprise that define how the virtual assistant should handle different types of user utterances, user emotions, or the like and generate appropriate responses.

The sample conversations are a set of example conversations that guide the one or more LLMs 142(1)-142(n) to understand the overall flow of the conversation for the intended use case. The one or more LLMs 142(1)-142(n) may learn patterns and gain a better understanding of the desired conversational behavior from the sample conversations.

A conversation path is a structured flow of interactions between a user and a virtual assistant comprising a sequence of conversation states that the conversation progresses through from a start point to an endpoint so as to fulfill the user's query/intent. An example conversation path is—“TransferType→P2PTransfer→CollectP2PTransferEntities→ConfirmP2PTransfer→CompleteP2PTransfer”.

A conversation state is a specific point within the conversation path where the virtual assistant performs a specific function or prompts the user to provide or confirm information. Each conversation state of the conversation path has a particular purpose, such as, for example, gathering information from the user, validating user input(s), presenting information to the user, providing feedback, or the like, which collectively guide the conversation forward. Further, the conversation state may comprise one or more transition conditions for the user to select or the virtual assistant may select based on the user input, which helps the virtual assistant to decide the conversation path to take. In the example conversation path—“TransferType→P2PTransfer→CollectP2PTransferEntities→ConfirmP2PTransfer→CompleteP2PTransfer”, the conversation states are “TransferType”, “P2PTransfer”, “CollectP2PTransferEntities”, “ConfirmP2PTransfer”, and “CompleteP2PTransfer”.

A conversation state description is a brief description about the purpose to be fulfilled or function to be performed when the conversation state is reached as part of the conversation between the user and the virtual assistant. For example, for the conversation state-“TransferType”, the conversation state description may comprise-“Find out the type of fund transfer the user wants to perform. Transfer types include: self-transfer; person-to-person transfer (P2PTransfer); and bill payment”.

A transition condition is a criterion that must be met for the conversation to move from one conversation state to another within the conversation path. The transition condition acts as a decision-making mechanism that determines when and how the conversation progresses through different conversation states, based on factors like, for example, user input(s), API call response(s), etc.

A conversation template allows for the creation of standardized and flexible conversation blueprints that can be dynamically adjusted to meet specific use case requirements. The conversation template may encapsulate a wide range of conversational dynamics such as, for example, greeting exchanges, interruption handling, inquiry responses, follow up queries, abrupt endings, transactional requests, support interactions, or the like. The conversation template may comprise one or more textual instructions that indicate a basic structure based on which the conversation experiments have to be generated. An example conversation template is disclosed below, although the conversation templates may be defined in any number of and/or types of configurations. The conversation templates may be predefined by one or more developers and stored on the virtual assistant platform 160, the data storage 180, or any other data storage or database internal or external to the virtual assistant server 150.

### Example Conversation Template:

Initiate the use-case;
Complete the use case flow; and
Ask the user two follow-up questions.

Further, input information comprising at least one of: the data inputs entered by the enterprise users via the experiment generator 164; the output of the experiment planner 174 comprising: conversation states, the conversation paths, and the descriptions of conversation paths; or the generated structured format (e.g., JSON) from the output of the experiment planner 174 may be provided to the one or more language models 142(1)-142(n) by the virtual assistant server 150 for generating the conversation experiments 184(1)-184(n), which are in turn used for evaluating and training the one or more virtual assistants 166(1)-166(n). In one example, the prompt templates 168 comprising one or more textual prompts may be used for providing the input information to the one or more language models 142(1)-142(n), for generating the conversation experiments 184(1)-184(n). A prompt may be defined as one or more text-based instructions provided to a language model, for example, an LLM. The prompt may comprise one or more sentences, one or more phrases, or a single word that provides context for the LLM to generate a required output. Examples of the steps or functions performed by the experiment generator 164 are illustrated and described further below in detail by way of the figures and description associated with the examples herein.

After the one or more virtual assistants 166(1)-166(n) are developed, trained, and deployed, the users of the enterprise may communicate with the one or more virtual assistants 166(1)-166(n) to, for example, purchase products, raise complaints, access services provided by the enterprise, know information about the products and services offered by the enterprise, or the like. Each of the one or more virtual assistants 166(1)-166(n) may be configured with one or more use cases for handling user utterances and each of the one or more use cases may be further defined using a dialog flow. A use case may be defined as a textual representation of what the user wants a virtual assistant to do. Additionally, to fulfill the use case of the user utterance, one or more entities/attributes should be identified from user utterances. For example, in a user utterance-“Book me a flight to Orlando for next Sunday,” the use case is “Book Flight”, and the entities are “Orlando” and “Sunday.” In one example, each of the one or more virtual assistants 166(1)-166(n) may be configured using other methods, such as software code in other configurations. A dialog flow may refer to the sequence of interactions in a conversation between a user and a virtual assistant 166(1). In one example, the dialog flow of a use case of the virtual assistant 166(1) comprises a series of interconnected nodes, for example, an intent node, one or more entity nodes, one or more invoke LLM nodes, one or more service nodes, one or more confirmation nodes, one or more message nodes, or the like, that define steps to be executed to fulfill the use case. The nodes of the dialog flow may include various types of interactions, such as, for example, questions, prompts, confirmations, and messages, and are configured to gather information from the user, provide information to the user, or perform a specific action. Each node of the dialog flow represents a specific point in the conversation and edges between the nodes represent possible paths that the conversation can take.

Referring back to FIG. 1B, the model evaluator 170 is a component of the virtual assistant platform 160 responsible for evaluating the one or more virtual assistants 166(1)-166(n) based on the conversation experiments 184(1)-184(n) generated using the experiment generator 164. In one example, the model evaluator 170 employs teacher-student model architecture for evaluating the one or more virtual assistants 166(1)-166(n), where an LLM is used as a base teacher model against which the virtual assistant 166(1), i.e. a student model, is evaluated on the generated conversation experiments 184(1)-184(n). By evaluating the virtual assistant 166(1) against the base teacher model (e.g., one of the language models 142(1)-142(n)), the model evaluator 170 may determine one or more of the conversation experiments 184(1)-184(n) for which the virtual assistant 166(1) is not performing as expected, hereinafter referred to as “failed conversation experiments”. The model evaluator 170 may be implemented, for example, using the one or more language models 142(1)-142(n), for example, one or more LLMs. Further, the experiment generator 164 using the one or more language models 142(1)-142(n) may generate additional conversation experiments based on the determined failed conversation experiments. In one example, instead of using the failed conversation experiments in entirety for generating the additional conversation experiments, only a summary of each of the failed conversation experiments may be used for generating the additional conversation experiments.

The model trainer 172 is a component of the virtual assistant platform 160 responsible for training the one or more virtual assistants 166(1)-166(n) based on the conversation experiments 184(1)-184(n) generated using the experiment generator 164. In one example, the model trainer 172 trains the virtual assistant 166(1) with the failed conversation experiments determined by the model evaluator 170 and the additional conversation experiments generated by the experiment generator 164 based on the failed conversation experiments. The model trainer 172 is implemented on the virtual assistant platform 160 as a service call, for example.

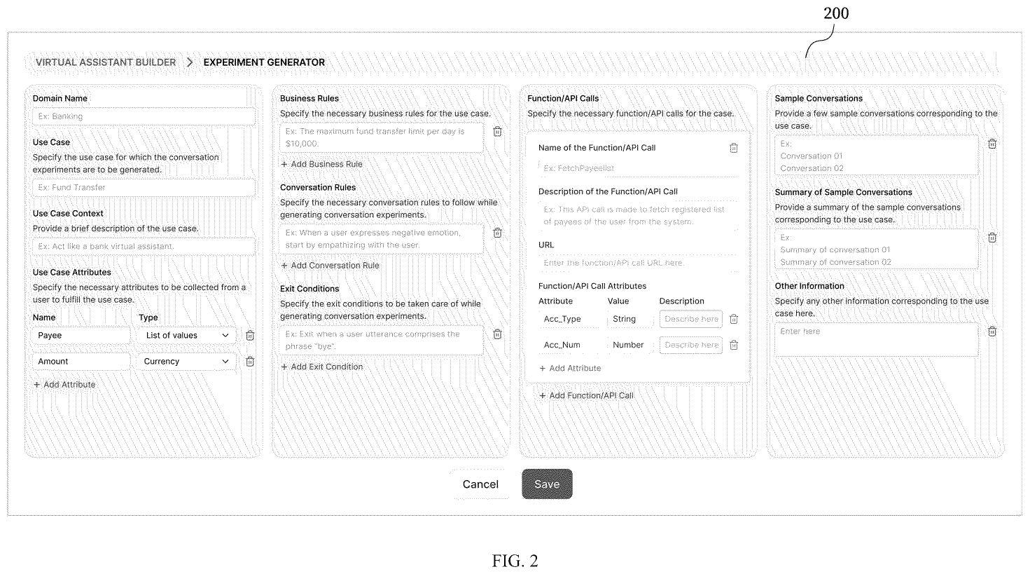

FIG. 2 is an example wireframe of a user interface (UI) 200 of the experiment generator 164 displayed in the GUI 122 of the developer device 120(1). The developer device 120(1) may display the example wireframe of the UI 200 of the experiment generator 164 based on instructions or information received from the virtual assistant server 150. In this example, the UI 200 of the experiment generator 164 comprises different data input sections via which the developer at the developer device 120(1) may enter/provide data inputs necessary for generating the conversation experiments 184(1)-184(n) for a use case. As illustrated in UI 200, the data input sections include fields for the developer at the developer device 120(1) to specify the domain name, the use case, the use case context, the use case attributes, the one or more business rules, the one or more conversation rules, the one or more exit conditions, the details about function/API calls, the predefined set of conversation templates, the one or more sample conversations, the summary of the one or more sample conversations, or any other information for generating conversation experiments 184(1)-184(n). Although, the UI 200 of the experiment generator 164 may comprise other types and/or numbers of data input fields in other configurations. Although in FIG. 2, the UI 200 is described as the UI of the experiment generator 164, in one example, the UI 200 may be the UI of the experiment planner 174. In another example, if the experiment planner 174 is implemented as part of the experiment generator 164, the UI 200 may be the UI of the experiment generator 164 but the data inputs provided by the developer at the developer device 120(1) via the different input sections of the UI 200 are first provided to the experiment planner 174 and the output of the experiment planner 174 may be used to generate the conversation experiments 184(1)-184(n).

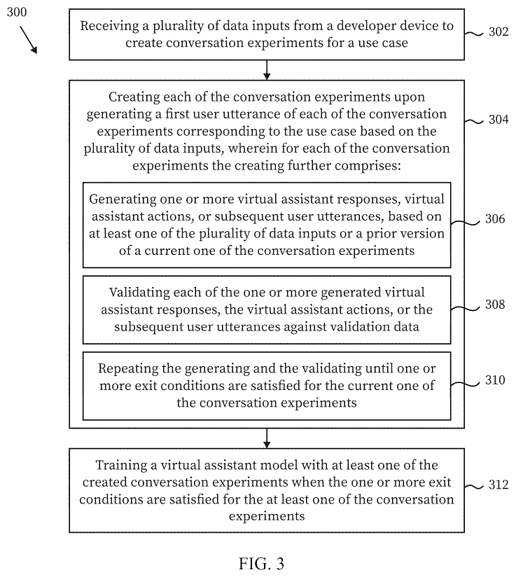

FIG. 3 is a flowchart of an exemplary method 300 for training a virtual assistant with generated conversation experiments by the virtual assistant server 150 of FIG. 1A. The exemplary method 300 may be performed by the system components illustrated in the virtual assistant server environment 100 of FIG. 1A. The virtual assistant server 150 may interact with other components of the virtual assistant server environment 100 to perform the steps of the exemplary method 300. In FIG. 3, the ordering of steps of method 300 is exemplary and any other ordering of the steps may be possible, not all the steps may be required, and in some implementations, some steps may be omitted, or other steps may be added.

At step 302, the virtual assistant server 150 receives a plurality of data inputs from a developer at a developer device 120(1) to create conversation experiments 184(1)-184(n) for a use case. In one example, the developer at the developer device 120(1) provides the plurality of data inputs via the UI 200 for creating the conversation experiments 184(1)-184(n).

At step 304, the virtual assistant server 150 creates each of the conversation experiments 184(1)-184(n) upon generating a first user utterance of each of the conversation experiments 184(1)-184(n) corresponding to the use case based on the plurality of data inputs received at step 302 from the develop device 120(1). Further, for creating each of the conversation experiments the virtual assistant server 150 performs steps 306, 308 and 310.

At step 306, based on at least one of the plurality of data inputs or a prior version of a current one of the conversation experiments 184(1)-184(n), the virtual assistant server 150 generates one or more: virtual assistant responses; virtual assistant actions; or subsequent user utterances.

At step 308, the virtual assistant server 150 validates each of the one or more generated: virtual assistant responses; the virtual assistant actions; or the subsequent user utterances against validation data. The validation data comprises one or more of: the prior version of the current one of the conversation experiments, a summary of the prior version of the current one of the conversation experiments, one or more business rules, one or more conversation rules, the one or more exit conditions, use case attributes, one or more conversation templates, a user sentiment, or one or more interruptions/digressions, although the validation data may comprise any number of and/or types of data in other examples.

Further, at step 308, only upon the successful validation of the corresponding one of the one or more virtual assistant responses, the virtual assistant actions, or the subsequent user utterances, the virtual assistant server 150 updates the current one of the conversation experiments 184(1)-184(n) with the successfully validated corresponding one of the one or more virtual assistant responses, the virtual assistant actions, or the subsequent user utterances.

At step 310, the virtual assistant server 150 repeats the generating step 306, and the validating and the updating step 308 until one or more exit conditions are satisfied for the current one of the conversation experiments 184(1)-184(n). The one or more exit conditions comprise: a user utterance or a virtual assistant response comprising one or more keywords indicating completion of the current one of the conversation experiment 184(1)-184(n), or a validation failure has occurred successively for a threshold number of times for the current one of the conversation experiments 184(1)-184(n). The one or more exit conditions may comprise, for example, the user utterance or the virtual assistant response comprising phrases/words indicating completion of a conversation (e.g., goodbye, bye, thanks, thank you, see you, end conversation, exit conversation, or the like), or a validation failure has occurred successively for a threshold number of times (e.g., 3 times in a row), although the exit conditions may comprise any numbers of and/or types of conditions in other examples. In one example, the virtual assistant server 150 may continue to create the conversation experiments until a predefined number of conversation experiments are created for the use case. For example, the developer may configure the experiment generator 164 to create ‘n’ conversation experiments for a use case ‘A’, based on which the virtual assistant server 150 using the experiment generator 164 repeats the steps 306 and 308 until ‘n’ conversation experiments are created for the use case ‘A’.

In the exemplary method 300, each user utterance generated may comprise one of: a query, a transactional request, or a response to the virtual assistant question, although the user utterances may comprise any number of and/or types of inputs or information in other examples. Each of the virtual assistant responses generated may comprise one of: a response to the user utterance, a confirmation prompt to the user, or a question to the user, although the virtual assistant responses may comprise any number of and/or types of messages or information in other examples. Additionally, in one example, each of the generated conversation experiments 184(1)-184(n) may be stored on the data storage 180 in the virtual assistant server 150, although the conversation experiments 184(1)-184(n) may be stored in other databases internal or external to the virtual assistant server 150 in other examples. Further, as part of generating each of the conversation experiments 184(1)-184(n), the virtual assistant server 150 stores and updates the version of each of the conversation experiments 184(1)-184(n) on the data storage 180.

Additionally, if any of the generated virtual assistant responses, the virtual assistant actions, or the subsequent user utterances fails the validation at step 308, a corresponding reason for validation failure may be generated and provided as a feedback to the one or more language models 142(1)-142(n) by the virtual assistant server 150 such that the one or more language models 142(1)-142(n) may consider the feedback while generating the subsequent: virtual assistant responses, virtual assistant actions, or user utterances to avoid any further validation failure. For example, if one of the one or more virtual assistant responses (e.g., virtual assistant response-1) fails the validation, the reason for validation failure may be generated by one of the one or more language models 142(1)-142(n) that validated the virtual assistant response-1. The reason for validation failure for the one or more virtual assistant responses/actions may comprise at least one of: the one or more business rules not adhered to by the one or more virtual assistant responses/actions, the one or more conversation rules not adhered to by the one or more virtual assistant responses/actions, or not adhering to sentiment of the previous user utterance, although the reason for validation failure for the one or more virtual assistant responses/actions may comprise any other types of and/or numbers of reasons in other examples. Thus, by validating each of the generated: subsequent user utterances, or the one or more virtual assistant actions or the one or more virtual assistant responses of each of the conversation experiments 184(1)-184(n) against the validation data and providing the feedback comprising the reason for validation failure to the one or more language models 142(1)-142(n), the virtual assistant server 150 may ensure that valid, reliable and robust conversation experiments 184(1)-184(n) are created.

The virtual assistant server 150 performs the steps 304-310 by prompting the one or more language models 142(1)-142(n) using one or more prompts from the prompt templates 168 predefined on the virtual assistant platform 160 based on a conversation stage of a conversation experiment that is being created. The developers may configure the prompt templates 168 depending on the tasks (e.g., user utterance generation, bot action/response generation, validation, or transition condition) for which the one or more language models 142(1)-142(n) might be prompted for creating the conversation experiments 184(1)-184(n). A prompt template may include key information and one or more instructions required by a language model to output a desired response. The predefined prompt templates 168 may comprise, for example, one or more textual prompts comprising instructions for: generating one or more user utterances; generating one or more variations of each of the user utterances; generating one or more virtual assistant actions/responses; validating the generated: one or more user utterances, one or more variations of the user utterances, or one or more virtual assistant actions/responses against the validation data, although the predefined prompt templates 168 may comprise any numbers of and/or types of textual prompts in other examples.

Referring back to FIG. 3, subsequently, at step 312, the virtual assistant server 150 trains a virtual assistant model (e.g., the virtual assistant 166(1)) with at least one of the conversation experiments 184(1)-184(n) created using the method steps 304-310 described above when the one or more exit conditions are satisfied for the at least one of the conversation experiments 184(1)-184(n). In this example the training is based on all of the created conversation experiments 184(1)-184(n). The process of training the virtual assistant model with the created conversation experiments 184(1)-184(n) is described further below in detail by way of the figures and description associated with the examples herein. In one example, prior to the training of the virtual assistant model (e.g., the virtual assistant 166(1)) at step 312, the virtual assistant 166(1) may be evaluated against a teacher language model using the created conversation experiments 184(1)-184(n). The process of evaluating the virtual assistant 166(1) is described in further detail below in view of FIG. 4C and the description thereof.

FIG. 4A is an exemplary functional block diagram 400 illustrating a few components of the virtual assistant server environment 100 of FIG. 1A that interacts with one another to implement the exemplary method 300 for generating the conversation experiments 184(1)-184(n) by the virtual assistant server 150 which may then be used to create, evaluate, and/or train one or more of the virtual assistants 166(1)-166(n). Although not illustrated in FIG. 4A, other components of the virtual assistant server environment 100 may also be used to implement the exemplary method 300.

Initially, for creating the conversation experiments 184(1)-184(n), the virtual assistant server 150 receives data inputs 402 from the developer at the developer device 120(1) via the UI 200 of the experiment generator 164. Further, as illustrated in FIG. 4A, the virtual assistant server 150 prompts a first user utterance generator 404 comprising the data inputs 402 and one or more instructions to receive a first user utterance that the users might use to start an interaction corresponding to a use case with the virtual assistant model, for example, the virtual assistant 166(1). In one example, one of the language models 142(1)-142(n) may be used as the first user utterance generator 404. The first user utterance may be one of a plurality of different types comprising, for example, seeking information, making transactional requests, or reporting issues. For example, the use case provided as part of the data inputs 402 may be “transfer funds”. In this example, for the “transfer funds” use case, the first user utterance generated by the first user utterance generator 404 as part of the conversation experiment 184(1) may be, for example, “I want to transfer funds”. In one example, the prompt provided to the first user utterance generator 404 may be configured by the developer in such a way that the first user utterance generator 404 may generate a plurality of user utterances that one or more users might use to initiate one or more interactions corresponding to the use case with the virtual assistant 166(1).

Additionally, for each of the conversation experiments 184(1)-184(n) that may be generated, upon generating the first user utterance by the first user utterance generator 404, the virtual assistant server 150 may create, store, and manage a version of the corresponding one of the conversation experiments 184(1)-184(n). In one example, a version of a conversation experiment may comprise one or more of: the use case associated with the conversation experiment; one or more attributes of the use case identified from the one or more user utterances; or a conversation transcript comprising the generated: one or more user utterances and/or one or more virtual assistant actions/responses, although the version of the conversation experiment may comprise any other types of and/or numbers of details in other examples. Further, in one example, for each of the conversation experiments 184(1)-184(n) that may be generated, the virtual assistant server 150 may store the created version of the corresponding one of the conversation experiments 184(1)-184(n) on the data storage 180, although the created version of each of the conversation experiments 184(1)-184(n) may be stored on any other types of and/or numbers of databases, data warehouses, data lakes, or data storages either internal and/or external to the virtual assistant server 150.

In the above described “transfer funds” use case example, until this point, the version of the conversation experiment 184(1) comprises the details below:

### Conversation Experiment 184(1):

Use case: Transfer Funds
First user utterance: I want to transfer funds

Further, upon generating the first user utterance by the first user utterance generator 404, for example, as part of the conversation experiment 184(1), the virtual assistant server 150 may prompt a bot action/response generator 406 (hereinafter referred to as “BAR generator 406”) comprising the data inputs 402, the first user utterance generated by the first user utterance generator 404, and one or more instructions to generate and output to the virtual assistant server 150 a bot action/response (hereinafter referred to as “BAR”) corresponding to the first user utterance. In one example, one of the language models 142(1)-142(n) may be used as the BAR generator 406. The BAR generated by the BAR generator 406, for example, may be one of the types comprising: prompting the user, informing the user, asking the user for a confirmation, making a function/API call, or providing an answer to the user, although the BAR generated by the BAR generator 406 may comprise any other types of and/or numbers of information in other examples. In the above described “transfer funds” use case example, for the first user utterance-“I want to transfer funds” of the conversation experiment 184(1), the BAR generator 406 may generate a corresponding BAR-“Sure, to whom do you want to transfer funds?”, for example.

Further, upon the BAR generator 406 generating the BAR corresponding to the first user utterance of the conversation experiment 184(1), the virtual assistant server 150 may prompt one or more BAR validators 408(1)-408(n) comprising: the previous version of the conversation experiment 184(1); the BAR generated; at least one or more parts of the data inputs 402 (such as, for example, the one or more business rules, the one or more conversation rules, the one or more exit conditions, the use case attributes, the details of function/API calls, or one or more conversation templates); and one or more instructions to perform one or more validations on the BAR generated by the BAR generator 406 and output validation results. For example, a first one of the BAR validators 408(1)-408(n) may validate the BAR against the one or more business rules, a second one of the BAR validators 408(1)-408(n) may validate the BAR against the one or more conversation rules, a third one of the BAR validators 408(1)-408(n) may validate the BAR against the one or more exit conditions, a fourth one of the BAR validators 408(1)-408(n) may validate the BAR against the use case attributes, a fifth one of the BAR validators 408(1)-408(n) may validate if the conversation experiment 184(1) being generated is in accordance with the one or more conversation templates, and so on. Although, the BAR validators 408(1)-408(n) may validate the BAR against any numbers of and/or types of data in other examples. In one example, instead of employing multiple BAR validators 408(1)-408(n), only a single BAR validator, for example, the BAR validator 408(1) may be employed for performing the one or more validations on the BAR. In one example, one of the language models 142(1)-142(n) may be used as the one or more BAR validators 408(1)-408(n). In another example, each of the BAR validators 408(1)-408(n) may be implemented using a different one of the language models 142(1)-142(n).

If one or more of the BAR validators 408(1)-408(n) determine a validation failure, then the one or more of the BAR validators 408(1)-408(n) that has determined the validation failure may generate a corresponding reason for validation failure and output the reason for validation failure as a feedback to the virtual assistant server 150. The virtual assistant server 150 may then re-prompt the BAR generator 406 to generate a new BAR corresponding to the first user utterance considering the validation failure feedback provided by the one or more of the BAR validators 408(1)-408(n) to avoid any further validation failures.

If all the BAR validators 408(1)-408(n) output a successful validation of the BAR, the virtual assistant server 150 may update the version of the conversation experiment 184(1) stored on the data storage 180 by adding the BAR to the conversation experiment 184(1). In the above described “transfer funds” use case example, until this point, the version of the conversation experiment 184(1) comprises the details below:

### Conversation Experiment 184(1):

Use case: Transfer Funds
First user utterance: I want to transfer funds
BAR: Sure, to whom do you want to transfer funds?

Upon updating the version of the conversation experiment 184(1), the virtual assistant server 150 prompts a subsequent user utterance generator 410 to generate a subsequent user utterance of the conversation experiment 184(1). In one example, one of the language models 142(1)-142(n) may be used as the subsequent user utterance generator 410. The prompt to the subsequent user utterance generator 410 may comprise: the version of the conversation experiment 184(1), the data inputs 402, and one or more instructions to generate the subsequent user utterance and output the generated subsequent user utterance to the virtual assistant server 150. The subsequent user utterance can be one of different types comprising, for example, providing information requested by the virtual assistant, asking for clarifications, a follow-up request, seeking information, redirecting/interrupting the conversation, or the like.

Upon generating the subsequent user utterance by the subsequent user utterance generator 410, the virtual assistant server 150 may prompt an utterance variation generator 412 to generate one or more variations of the subsequent user utterance generated by the subsequent user utterance generator 410. In one example, the developer at the developer device 120(1) may preconfigure as part of the prompt to the utterance variation generator 412 the number of variations of the subsequent user utterance to be generated. The variations may comprise, for example, change in sentiment of the subsequent user utterance, change in tense of the subsequent user utterance, change in tone of the subsequent user utterance, changing active voice to passive voice and vice versa, use of synonyms for one or more words/phrases of the subsequent user utterance, changing a request to a command and vice-versa, or the like. In one example, one of the language models 142(1)-142(n) may be used as the utterance variation generator 412. The prompt to the utterance variation generator 412 may comprise: the subsequent user utterance generated by the subsequent user utterance generator 410 and one or more instructions to generate and output the one or more variations of the subsequent user utterance to the virtual assistant server 150. This ensures that the conversation experiments 184(1)-184(n) that are generated cover the possible ways in which the users can converse with the virtual assistant 166(1), which in turn ensures that the virtual assistant 166(1) can smoothly handle and take the conversation forward even when the users phrase their queries, requests or statements in different ways.

Further, upon generating the one or more variations of the subsequent user utterance by the utterance variation generator 412, the virtual assistant server 150 may prompt an utterance variation validator 414 to validate each of the one or more utterance variations against the generated subsequent utterance for any change in key information. A subsequent user utterance may comprise the key information such as, for example, the one or more use case attributes (e.g., account number, payee name, account type, etc.), one or more new use case requests (e.g., interruptions, follow-up query, etc.), or the like, although the key information in the subsequent user utterance may comprise any number of and/or types of information in other examples. For example, the utterance variation validator 414 may check if each utterance variation of the subsequent user utterance comprises the same key information that is identified in the subsequent user utterance. In one example, one of the language models 142(1)-142(n) may be used as the utterance variation validator 414.

If the utterance variation validator 414 identifies a validation failure for one or more utterance variations, the utterance variation validator 414 may generate a corresponding reason for the validation failure and output the reason for the validation failure as a feedback to the virtual assistant server 150. The virtual assistant server 150 may then re-prompt the utterance variation generator 412 to generate new utterance variations corresponding to the subsequent user utterance for which the validation failed considering the feedback provided by the utterance variation validator 414 to avoid any further validation failures. This ensures correctness, accuracy, and quality in the conversation experiments 184(1)-184(n) being generated. The reason for validation failure may comprise: the generated subsequent user utterance, the utterance variation that has failed the validation, and a brief description of key information change between the generated subsequent user utterance and the corresponding utterance variation.

Further, the virtual assistant server 150 may prompt the user utterance validators 416(1)-416(n) to validate each of: the subsequent user utterance generated by the subsequent user utterance generator 410 and the one or more utterance variations that succeeded the validation performed by the utterance variation validator 414 against: the business rules, the exit conditions, the use case attributes, the conversation templates, etc. The prompt provided to the user utterance validators 416(1)-416(n) may comprise: the version of the conversation experiment 184(1), the data inputs 402, and one or more instructions to perform one or more validations on each of: the subsequent user utterance and the utterance variations that succeeded the validation performed by the utterance variation validator 414. For example, a user utterance validator 416(1) may validate against the one or more business rules, a user utterance validator 416(2) may validate against the one or more exit conditions (to check for conversation completion, interruptions, follow-up requests, or the like), a user utterance validator 416(3) may validate if the conversation experiment 184(1) being generated is in accordance with the one or more conversation templates provided as part of the data inputs 402, and so on. Although, the user utterance validators 416(1)-416(n) may perform validations against any numbers of or types of data in other examples. In one example, instead of employing multiple user utterance validators 416(1)-416(n), only a single user utterance validator may be employed for performing the one or more validations. In one example, one of the language models 142(1)-142(n) may be used as the one or more user utterance validators 416(1)-416(n). In another example, each of the user utterance validators 416(1)-416(n) may be implemented using a different one of the language models 142(1)-142(n).

Further, in one example, if one or more user utterance validators 416(1)-416(n) determine a validation failure for any one of: the subsequent user utterance or the one or more utterance variations, the one or more user utterance validators 416(1)-416(n) may generate a corresponding reason for the validation failure and output the reason for the validation failure as a feedback to the virtual assistant server 150. In one example, as illustrated in FIG. 4A, if the subsequent user utterance fails the validation, the virtual assistant server 150 may re-prompt the subsequent user utterance generator 410 to generate a new subsequent user utterance considering the feedback provided by the one or more user utterance validators 416(1)-416(n) to avoid any further validation failures. Although not illustrated in FIG. 4A, in another example, if one or more of the utterance variations of the subsequent user utterance fail the validation performed by the one or more user utterance validators 416(1)-416(n), the virtual assistant server 150 may re-prompt the utterance variation generator 412 to generate one or more new utterance variations of the subsequent user utterance considering the feedback provided by the one or more user utterance validators 416(1)-416(n) to avoid any further validation failures.

Further, upon the subsequent user utterance succeeding the validation performed by the one or more user utterance validators 416(1)-416(n), the virtual assistant server 150 updates the previous version of the conversation experiment 184(1) by appending to it the subsequent user utterance. Additionally, the virtual assistant server 150 creates one or more additional conversation experiments by independently appending each of the utterance variations of the subsequent user utterance that succeeded the validation performed by the one or more user utterance validators 416(1)-416(n) to the previous version of the conversation experiment 184(1). Thus, the virtual assistant server 150 may generate a plurality of conversation experiments 184(1)-184(n) from the initially generated first user utterance and the BAR.

For example, in the above described “transfer funds” use case example, the version of the conversation experiment 184(1) may be updated as below:

### Conversation Experiment 184(1):

Use case: Transfer Funds
First user utterance: I want to transfer funds
BAR: Sure, to whom do you want to transfer funds?
Subsequent user utterance: To Bob

Similarly, in the above described “transfer funds” use case example, the one or more additional conversation experiments that may be created using the one or more utterance variations as below:

### Conversation Experiment 184(2):

Use case: Transfer Funds
First user utterance: I want to transfer funds
BAR: Sure, to whom do you want to transfer funds?
Utterance variation-1: Payee name is Bob

### Conversation Experiment 184(3):

Use case: Transfer Funds
First user utterance: I want to transfer funds
BAR: Sure, to whom do you want to transfer funds?
Utterance variation-2: Please transfer to Bob

Further, the created one or more conversation experiments (i.e., 184(1)-184(3) in the above “transfer funds” use case example) may be provided to the BAR generator 406 by the virtual assistant server 150 along with the data inputs 402 and one or more instructions to generate a subsequent bot action/response corresponding to each of the one or more conversation experiments 184(1)-184(3). The steps performed by the BAR generator 406, the BAR validators 408(1)-408(n), the subsequent user utterance generator 410, the utterance variation generator 412, the utterance variation validator 414, and the user utterance validators 416(1)-416(n) may be repeated until: the one or more exit conditions are satisfied for each of the conversation experiments 184(1)-184(n) being generated or the required number of conversation experiments are generated. The conversation experiments 184(1)-184(n) that are generated by the experiment generator 164 are stored on the data storage 180 of the virtual assistant server 150. In one example, the conversation experiments 184(1)-184(n) that are generated by the experiment generator 164 may be stored in one or more databases that are internal or external to the virtual assistant server 150, although the conversation experiments 184(1)-184(n) may be stored in any number of and/or types of databases or storages in other examples.

The data inputs 402 may be provided to: the first user utterance generator 404, the BAR generator 406, the BAR validators 408(1)-408(n), the subsequent user utterance generator 410, and the user utterance validators 416(1)-416(n) either in natural language text or in a structured data format, e.g., JSON format.

In one example, the experiment generator 164 orchestrates all the communications, processes, and/or data transfers between different components illustrated in FIG. 4A. In another example, a different orchestrator module may be configured to orchestrate all the communications, processes, and/or data transfers between different components illustrated in FIG. 4A. In another example, the virtual assistant platform 160 may manage all the communications, processes, and/or data transfers between different components illustrated in FIG. 4A.

FIG. 4B is an exemplary functional block diagram 420 of the experiment planner 174 illustrating components of the virtual assistant server environment 100 of FIG. 1A that interact with one another to generate one or more possible conversation paths from the data inputs 402 received from the one or more developer devices 120(1)-120(n). Further, it may be understood that the steps illustrated in FIG. 4B do not have to take place in the sequence illustrated. Furthermore, it may be understood that one or more components and the one or more steps illustrated in FIG. 4B may not be needed for the experiment planner 174. Although not illustrated in FIG. 4B, other components of the virtual assistant server environment 100 may also be used to implement the exemplary flow 420 of the experiment planner 174.

As illustrated in FIG. 4B, the experiment planner 174 comprises: a state generator 422, a state validator 424, a conversation path generator 426, a conversation path validator 428, a description generator 430, and a description validator 432. In one example, the experiment planner 174 may also comprise a JSON generator 434.

Initially, the virtual assistant server 150 prompts the state generator 422 with the data inputs 402 and one or more instructions to generate possible conversation states in natural language text based on the data inputs 402. A conversation state is a specific point within a conversation where a virtual assistant performs a specific function or prompts the user to provide or confirm information. Each conversation state has a particular purpose, such as, for example, gathering information from the user, performing one or more tool interactions, executing one or more function calls, validating user input(s), presenting information to the user, providing feedback, or the like. Additionally, each of the generated conversation states may comprise one or more transition conditions that has to be satisfied to move the conversation from one state to another state.

Upon the state generator 422 generating the possible conversation states, the virtual assistant server 150 may prompt the state validator 424 to validate the conversation states against use case description and/or the business rules, although the conversation states may be validated against any other types and/or numbers of data in other examples. In one example, when any of the conversation states fails the validation, the state validator 424 may generate a corresponding reason for validation failure in natural language text. The reason for validation failure of the conversation state may indicate that the conversation state is not adhering to the one or more business rules and/or the conversation state is not relevant to the use case description. The reason for validation failure of the conversation state may be provided as a feedback to the state generator 422 by the virtual assistant server 150 so that any subsequent conversation states generated by the state generator 422 may not fail the validation.

Further, the virtual assistant server 150 prompts the conversation path generator 426 with one or more instructions to generate one or more possible conversation paths that a conversation corresponding to the use case might progress to, based on the data inputs 402 and the conversation states that are successfully validated by the state validator 424. A conversation path is a structured flow of interactions between the user and the virtual assistant comprising a sequence of conversation states that the conversation progresses through from a start point to an endpoint so as to fulfill the use case.

Upon the conversation path generator 426 generating the one or more possible conversation paths, the virtual assistant server 150 may prompt the conversation path validator 428 to validate the generated one or more conversation paths against the use case description and/or the business rules, although the conversation paths may be validated against any other types and/or numbers of data in other examples. In one example, when any of the conversation paths fails the validation, the conversation path validator 428 may generate a corresponding reason for validation failure in natural language text. The reason for validation failure of the conversation path may indicate that the conversation path is not adhering to the one or more business rules and/or the conversation path is not relevant to the use case description. The reason for validation failure of the conversation path may be provided as a feedback to the conversation path generator 426 by the virtual assistant server 150 so that any subsequent conversation paths generated by the conversation path generator 426 may not fail the validation.

Further, the virtual assistant server 150 prompts the description generator 430 with one or more instructions to generate, based on the data inputs 402, textual descriptions for each of the one or more conversation paths that are successfully validated by the conversation path validator 428. The textual description of a conversation path comprises description of each of the conversation states of the conversation path, or one or more global transition conditions. Further, the description of each of the conversation states comprises descriptions about at least one of: the purpose of the conversation state, the one or more actions to be performed by the virtual assistant at the conversation state, the one or more function calls to be executed by the virtual assistant at the conversation state, the one or more tool interactions to be performed by the virtual assistant at the conversation state, or the one or more transition conditions associated with the conversation state. Although, the description of the conversation state may comprise other types of and/or numbers of details in other examples. The one or more global transition conditions may refer to the transition conditions, such as, for example, interruptions/digressions (e.g., agent transfer), FAQs, or the like that are applicable across all the conversation states and all the conversation paths. The description of a global transition condition may comprise at least one of: the one or more actions to be performed by the virtual assistant, the one or more function calls to be executed by the virtual assistant, the one or more tool interactions to be performed by the virtual assistant, the one or more database interactions to be performed by the virtual assistant, or the like.

Upon the description generator 430 generating the descriptions for each of the one or more conversation paths, the virtual assistant server 150 may prompt the description validator 432 to validate the generated descriptions of each of the one or more conversation paths against the use case description and/or the business rules, although the descriptions of the conversation paths may be validated against any other types and/or numbers of data in other examples. In one example, when the description of any of the conversation paths fails the validation, the description validator 432 may generate a corresponding reason for validation failure in natural language text. The reason for validation failure of the conversation path description may indicate that the conversation path description is not adhering to the one or more business rules and/or the conversation path description is not relevant to the use case description. The reason for validation failure of the conversation path description may be provided as a feedback to the description generator 430 by the virtual assistant server 150 so that any subsequent conversation path descriptions generated by the description generator 430 may not fail the validation.

Subsequently, as illustrated in FIG. 4B, the virtual assistant server 150 provides the JSON generator 434 with the unstructured text data comprising: the successfully validated conversation states, the successfully validated one or more conversation paths, and the successfully validated conversation path descriptions, to generate a structured representation (i.e., JSON output 436) of the conversation states, the one or more conversation paths, and the conversation path descriptions.

In one example, one of the language models 142(1)-142(n) may be used to perform all the functions of: the state generator 422, the state validator 424, the conversation path generator 426, the conversation path validator 428, the description generator 430, the description validator 432, and the JSON generator 434. In another example, different ones of the language models 142(1)-142(n) may be employed to implement functions of each of: the state generator 422, the state validator 424, the conversation path generator 426, the conversation path validator 428, the description generator 430, the description validator 432, and the JSON generator 434.

Referring back to FIG. 4A, in one example, along with the data inputs 402, the experiment generator 164 may be also provided with the output of the experiment planner 174 (either the unstructured text output or the JSON output 436) comprising details of: the conversation states, the one or more conversation paths, and the descriptions of each of the one or more conversation paths, to create the conversation experiments 184(1)-184(n). In this example, instead of providing the entire output (either the unstructured text output or the JSON output 436) of the experiment planner 174 to the experiment generator 164 at once, each of the one or more successfully validated conversation paths generated by the experiment planner 174 is broken down into segments (comprising pairs of successive conversation states) and only the details corresponding to one of the segments (i.e., pairs of the successive conversation states of one of the successfully validated conversation paths) may be provided in each pass to the experiment generator 164. This approach allows the experiment generator 164 to process details of each segment of each conversation path independently with better efficiency and finer control on how the conversation experiments 184(1)-184(n) are created with reduced complexity.

The JSON representation of the output of the experiment planner 174, i.e., the JSON output 436, represents a detailed state machine comprising information about: every possible conversation state, every possible conversation path, tool interactions, and transition conditions (conversation state level and global transition conditions). Thus, the output of the experiment planner 174 serves as a foundational blueprint for the experiment generator 164 detailing how and what kind of conversation experiments 184(1)-184(n) to be created with finer control and better efficiency.

FIG. 4C is an exemplary functional block diagram 450 illustrating a few components of the virtual assistant server environment 100 of FIG. 1A that interacts with one another to create conversation experiments 184(1)-184(n), which may be then used to evaluate and/or train a virtual assistant model, e.g., the virtual assistant 166(1). Although not illustrated in FIG. 4C, other components of the virtual assistant server environment 100 may also be used to implement the exemplary flow 450 described below.

As illustrated in FIG. 4C, initially the data inputs 402 and/or the output of the experiment planner 174, i.e., the JSON output 436, are provided as input to the experiment generator 164 to create the conversation experiments 184(1)-184(n), as described above in view of FIG. 4A and the corresponding description. Further, as illustrated in FIG. 4C, the created conversation experiments 184(1)-184(n) are provided as inputs simultaneously to the model evaluator 170 and the virtual assistant 166(1). In one example, in each of the conversation experiments 184(1)-184(n) created by the experiment generator 164, for each of the user utterances generated, the corresponding BAR generated by the BAR generator 406 is considered as an expected output by the model evaluator 170 when evaluating the virtual assistant 166(1) using the conversation experiments 184(1)-184(n). Further, in this example, when evaluating the virtual assistant 166(1) using the conversation experiments 184(1)-184(n), the model evaluator 170 considers a response generated by the virtual assistant 166(1) as an actual output. When evaluating the virtual assistant 166(1) using the conversation experiments 184(1)-184(n), the model evaluator 170 compares the response generated by the virtual assistant 166(1) for each of the user utterances of each of the conversation experiments 184(1)-184(n) with the corresponding BAR. For example, the responses generated by the virtual assistant 166(1) for each of the user utterances in a conversation experiment 184(1), are evaluated by the model evaluator 170 against the corresponding BAR in the conversation experiment 184(1). In this example, the model evaluator 170 may evaluate each of the responses of the virtual assistant 166(1) against the corresponding BAR response in terms of parameters, such as, for example, relevance, completeness, information accuracy, coherence, informativeness, whether the required information is extracted from the user utterance to make an API/function call, etc., although the model evaluator 170 may evaluate the responses of the virtual assistant 166(1) for any other types of and/or numbers of parameters in other examples. In one example, one of the language models 142(1)-142(n) may be used as the model evaluator 170.

Further, as illustrated in FIG. 4C, when the model evaluator 170 successfully evaluates each of the responses generated by the virtual assistant 166(1) for each of the user utterances of each of the conversation experiments 184(1)-184(n) against the corresponding BAR, the model evaluator 170 exits from the evaluation process.

Further, as illustrated in FIG. 4C, when one or more responses of the virtual assistant 166(1) for one or more user utterances of one or more of the conversation experiments 184(1)-184(n) fail the evaluation against the corresponding BAR (hereinafter referred to as “one or more failed conversation experiments”), the virtual assistant server 150 provides the one or more failed conversation experiments to the model trainer 172, using which the model trainer 172 may train the virtual assistant 166(1) such that the virtual assistant 166(1) can efficiently handle such conversations in real-time with the users. Furthermore, the virtual assistant server 150 may prompt the experiment generator 164 with one or more failed conversation experiments, the data inputs 402 and the output of the experiment planner 174, to generate additional conversation experiments that are similar to the one or more failed conversation experiments, which may be then used to further evaluate and train the virtual assistant 166(1) as described above.

In one example, before evaluating the virtual assistant 166(1), the model trainer 172 may first train the virtual assistant 166(1) with 80% of the created conversation experiments 184(1)-184(n). Upon training the virtual assistant server 166(1), the model evaluator 170 may evaluate the virtual assistant 166(1) using the remaining 20% of the created conversation experiments 184(1)-184(n) as described above.

In another example, historical real-time conversations between the users and human agents of the enterprise may be also provided as part of the data inputs 402 for creating the conversation experiments 184(1)-184(n) or the additional conversation experiments that may be used for fine-tuning the virtual assistant 166(1).

The above described methods, processes, or steps may be repeated until the virtual assistant 166(1) showcases the desired performance.

In one example, the virtual assistant platform 160 may manage all the communications, processes, and/or data transfers between different components illustrated in FIG. 4C.

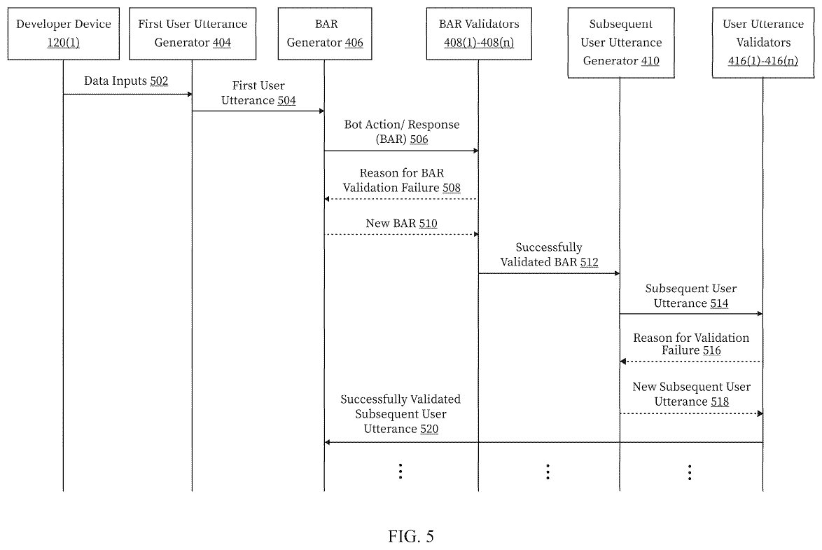

Referring to FIG. 5, a sequence diagram illustrating an exemplary method for generating the conversation experiments 184(1)-184(n) as described above in view of FIG. 4A. It may be understood that FIG. 5 depicts a few steps involved in the process of generating the conversation experiments 184(1)-184(n) using the experiment generator 164, although other types and/or numbers of steps may be performed in other configurations. Further, it may be understood that the steps illustrated in FIG. 5 do not have to take place in the sequence illustrated.

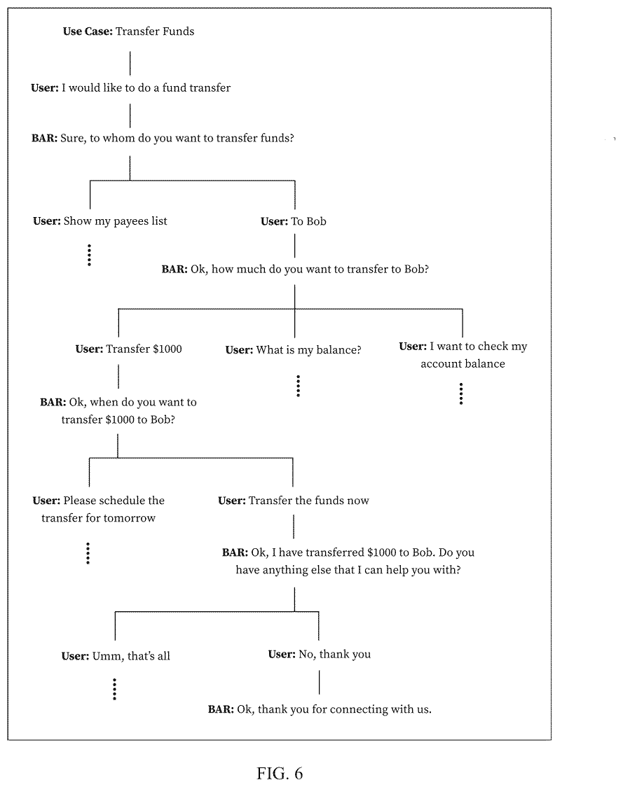

Referring to FIG. 6, an example conversation tree that illustrates the way in which the conversation experiments 184(1)-184(n) are generated for a given use case-transfer funds.

Thus, using the above described processes of generating conversation experiments and using the generated conversation experiments to train, evaluate, and optimize the virtual assistants, the enterprises can drastically reduce the time to create, train, optimize, and deploy conversational virtual assistants.

Advantages of the disclosed invention:

By merely inputting use case details, conversation templates, business, and conversation rules, exit conditions, details about function/API calls, and sample conversations, enterprises can quickly create, train, evaluate, optimize, and deploy virtual assistants that are tailored to business specific requirements.

Employing the conversation templates and/or the experiment planner ensures controlled and efficient generation of conversation experiments that cover diverse use case scenarios and at the same time adhering to specific operational and compliance requirements of the enterprises.

By automatically generating conversation experiments, the invention described in the present disclosure allows for the quick evaluation of virtual assistants, focusing on essential conversational aspects.

Validation of each of the generated user utterances and the bot actions/responses ensures generation of quality conversation experiments that adhere to enterprise's rules and requirements.

Enterprises can easily train the virtual assistants for underperforming scenarios in real-world user conversations by quickly generating conversation experiments for the underperforming scenarios, which ensures continuous improvement of the virtual assistants.

The output of the experiment planner may serve as a foundational blueprint for the experiment generator detailing how and what kind of conversation experiments to be generated with finer control and better efficiency.

Having thus described the basic concept of the invention, it will be rather apparent to those skilled in the art that the foregoing detailed disclosure is intended to be presented by way of example only and is not limiting. Various alterations, improvements, and modifications will occur and are intended for those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A method implemented by a virtual assistant server comprising:
receiving a plurality of data inputs from a developer device to create conversation experiments for a use case;
creating each of the conversation experiments upon generating a first user utterance of each of the conversation experiments corresponding to the use case based on the plurality of data inputs, wherein for each of the conversation experiments the creating further comprises:
generating one or more virtual assistant responses, virtual assistant actions, or subsequent user utterances, based on at least one of the plurality of data inputs or a prior version of a current one of the conversation experiments;
validating each of the one or more generated virtual assistant responses, the virtual assistant actions, or the subsequent user utterances against validation data, wherein the current one of the conversation experiments is updated only upon the successful validation of the corresponding one of the one or more virtual assistant responses, the virtual assistant actions, or the subsequent user utterances; and
repeating the generating and the validating until one or more exit conditions are satisfied for the current one of the conversation experiments; and
training a virtual assistant model with at least one of the created conversation experiments when the one or more exit conditions are satisfied for the at least one of the conversation experiments.

2. The method of claim 1, wherein the plurality of data inputs comprise: a domain name, a use case name, a use case description, use case attributes, one or more business rules, one or more conversation rules, the one or more exit conditions, details of function calls, one or more sample conversations, a summary of the one or more sample conversations, or one or more conversation templates.

3. The method of claim 1, wherein the plurality of data inputs received from the user device is in natural language text.

4. The method of claim 1, wherein the plurality of data inputs received from the user device is in a structured data format.

5. The method of claim 4, wherein the structured data format is a JavaScript Object Notation (JSON) format.

6. The method of claim 1, wherein the validation data comprises one or more of: the prior version of the current one of the conversation experiments, one or more business rules, one or more conversation rules, the one or more exit conditions, use case attributes, one or more conversation templates, or user sentiment.

7. The method of claim 1, further comprising, prior to the repeating, generating a reason for validation failure when at least one of the one or more subsequent user utterances, the one or more virtual assistant responses, or the one or more virtual assistant actions fails the validation.

8. The method of claim 7, wherein the reason for validation failure is used as feedback for generating: one or more subsequent virtual assistant responses, one or more subsequent virtual assistant actions, or the one or more subsequent user utterances, to avoid any further validation failures.

9. The method of claim 1, wherein the one or more exit conditions comprise: a user utterance or a virtual assistant response comprising one or more keywords indicating completion of a conversation experiment, or a validation failure has occurred successively for a threshold number of times for the current one of the conversation experiments.

10. The method of claim 1, wherein the generating and the validating are performed by prompting one or more language models.

11. A virtual assistant server comprising:
one or more processors; and
a memory coupled to the one or more processors which are configured to execute programmed instructions stored in the memory to:
receive a plurality of data inputs from a developer device to create conversation experiments for a use case;
create each of the conversation experiments upon generating a first user utterance of each of the conversation experiments corresponding to the use case based on the plurality of data inputs, wherein for each of the conversation experiments the creating further comprises:
generating one or more virtual assistant responses, virtual assistant actions, or subsequent user utterances, based on at least one of the plurality of data inputs or a prior version of a current one of the conversation experiments;
validating each of the one or more generated virtual assistant responses, the virtual assistant actions, or the subsequent user utterances against validation data, wherein the current one of the conversation experiments is updated only upon the successful validation of the corresponding one of the one or more virtual assistant responses, the virtual assistant actions, or the subsequent user utterances; and
repeating the generating and the validating until one or more exit conditions are satisfied for the current one of the conversation experiments; and
train a virtual assistant model with at least one of the created conversation experiments when the one or more exit conditions are satisfied for the at least one of the conversation experiments.

12. The virtual assistant server of claim 11, wherein the plurality of data inputs comprise: a domain name, a use case name, a use case description, use case attributes, one or more business rules, one or more conversation rules, the one or more exit conditions, details of function calls, one or more sample conversations, a summary of the one or more sample conversations, or one or more conversation templates.

13. The virtual assistant server of claim 11, wherein the plurality of data inputs received from the user device is in natural language text.

14. The virtual assistant server of claim 11, wherein the plurality of data inputs received from the user device is in a structured data format.

15. The virtual assistant server of claim 14, wherein the structured data format is a JavaScript Object Notation (JSON) format.

16. The virtual assistant server of claim 11, wherein the validation data comprises one or more of: the prior version of the current one of the conversation experiments, one or more business rules, one or more conversation rules, the one or more exit conditions, use case attributes, one or more conversation templates, or user sentiment.

17. The virtual assistant server of claim 11, wherein prior to the repeating, the one or more processors are further configured to execute the programmed instructions stored in the memory to: generate a reason for validation failure when at least one of the one or more subsequent user utterances, the one or more virtual assistant responses, or the one or more virtual assistant actions fails the validation.

18. The virtual assistant server of claim 17, wherein the reason for validation failure is used as feedback to generate: one or more subsequent virtual assistant responses, one or more subsequent virtual assistant actions, or the one or more subsequent user utterances, to avoid any further validation failures.

19. The virtual assistant server of claim 11, wherein the one or more exit conditions comprise: a user utterance or a virtual assistant response comprising one or more keywords indicating completion of a conversation experiment, or a validation failure has occurred successively for a threshold number of times for the current one of the conversation experiments.

20. The virtual assistant server of claim 11, wherein the generating and the validating are performed by prompting one or more language models.

21. A non-transitory computer-readable medium storing instructions which when executed by one or more processors, causes the one or more processors to:
receive a plurality of data inputs from a developer device to create conversation experiments for a use case;
create each of the conversation experiments upon generating a first user utterance of each of the conversation experiments corresponding to the use case based on the plurality of data inputs, wherein for each of the conversation experiments the creating further comprises:
generating one or more virtual assistant responses, virtual assistant actions, or subsequent user utterances, based on at least one of the plurality of data inputs or a prior version of a current one of the conversation experiments;
validating each of the one or more generated virtual assistant responses, the virtual assistant actions, or the subsequent user utterances against validation data, wherein the current one of the conversation experiments is updated only upon the successful validation of the corresponding one of the one or more virtual assistant responses, the virtual assistant actions, or the subsequent user utterances; and
repeating the generating and the validating until one or more exit conditions are satisfied for the current one of the conversation experiments; and
train a virtual assistant model with at least one of the created conversation experiments when the one or more exit conditions are satisfied for the at least one of the conversation experiments.

22. The non-transitory computer-readable medium 21, wherein the plurality of data inputs comprise: a domain name, a use case name, a use case description, use case attributes, one or more business rules, one or more conversation rules, the one or more exit conditions, details of function calls, one or more sample conversations, a summary of the one or more sample conversations, or one or more conversation templates.

23. The non-transitory computer-readable medium 21, wherein the plurality of data inputs received from the user device is in natural language text.

24. The non-transitory computer-readable medium 21, wherein the plurality of data inputs received from the user device is in a structured data format.

25. The non-transitory computer-readable medium 24, wherein the structured data format is a JavaScript Object Notation (JSON) format.

26. The non-transitory computer-readable medium 21, wherein the validation data comprises one or more of: the prior version of the current one of the conversation experiments, one or more business rules, one or more conversation rules, the one or more exit conditions, use case attributes, one or more conversation templates, or user sentiment.

27. The non-transitory computer-readable medium 21, further comprises stored instructions which when executed by the one or more processors prior to the repeating, causes the one or more processors to generate a reason for validation failure when at least one of the one or more subsequent user utterances, the one or more virtual assistant responses, or the one or more virtual assistant actions fails the validation.

28. The non-transitory computer-readable medium 27, wherein the reason for validation failure is used as feedback to generate: one or more subsequent virtual assistant responses, one or more subsequent virtual assistant actions, or the one or more subsequent user utterances, to avoid any further validation failures.

29. The non-transitory computer-readable medium 21, wherein the one or more exit conditions comprise: a user utterance or a virtual assistant response comprising one or more keywords indicating completion of a conversation experiment, or a validation failure has occurred successively for a threshold number of times for the current one of the conversation experiments.

30. The non-transitory computer-readable medium 21, wherein the generating and the validating are performed by prompting one or more language models.
